(19) United States
(12) Patent Application Publication
(10) Pub. No.: US 2007/0220272 A1
(43) Pub. Date: Sep. 20, 2007

(54) Transaction authentication card

(76) Inventors: Steven E. Campisi, Elkhorn, NE (US); Mark Ancona, Elkhorn, NE (US)

Correspondence Address: SUITER WEST SWANTZ PC LLO, 14301 FNB PARKWAY, SUITE 220, OMAHA, NE, 68154, US

(21) Appl. No.: 10/603,887

(22) Filed: Jun. 25, 2003

Related U.S. Application Data
(60) Provisional application No. 60/391,532, filed on Jun. 25, 2002.
(60) Provisional application No. 60/417,607, filed on Oct. 10, 2002.
(60) Provisional application No. 60/463,297, filed on Apr. 16, 2003.

(51) Int. Cl. H04K 1/00

(52) U.S. Cl. 713/186

(57) ABSTRACT

A transaction authentication card uses a biometric input and a wireless output. The biometric input may be a sensor pad on the transaction authentication card that measures blood flow patterns, temperature, and/or fingerprint patterns to identify a user to permit access. The transaction authentication card is preferably substantially rigid, but may be formed to have some flexibility. Power to the transaction authentication card may be accomplished through an internal battery that is optionally rechargeable. Biometric data is stored on the card only and used for user verification. Biometric data will not be transferred from the card. If authorized biometric data is authenticated the card will transmit a wireless access code to a proximity reader or transaction equipment.

### CROSS REFERENCE TO RELATED APPLICATIONS

The present application is a non-provisional patent application claiming priority under 35 U.S.C. 119(e) to U.S. Provisional Patent Application Ser. Nos. 60/463,297, filed Apr. 16, 2003, 60/417,607, filed Oct. 10, 2002, and 60/391,532, filed Jun. 25, 2002, herein incorporated by reference.

### FIELD OF THE INVENTION

The present invention generally relates to transaction authentication cards, and particularly to transaction authentication cards having a biometric sensor for authentication.

### BACKGROUND OF THE INVENTION

Security is of concern to businesses and individuals for a plethora of reasons, including the prevention of identity theft, property theft, industrial espionage, invasion of privacy, and terrorism. Accordingly, transaction authentication cards have been developed that allow an individual to access a room or building or to access sensitive information. The current security provided by a transaction authentication card is inadequate for secure operations such as physical access control, logical access control, and financial transaction authentication because unauthorized users may now use transaction authentication cards. There is a need for a reliable way to authenticate a user.

Therefore, it would be desirable to provide a transaction authentication card that uses biometrics to verify that the person in possession of the card is in fact the authorized and authenticated user.

### SUMMARY OF THE INVENTION

Accordingly, the present invention is directed to a transaction authentication card incorporating biometric verification technologies and methods.

In a first aspect of the present invention, a proximity card, comprises a biometric sensor for sensing a biometric feature of a user; a memory; a processor for retrieving stored biometric data from the card's memory, the processor having a fingerprint matching algorithm for comparing a biometric feature of a user with the stored biometric data in the card; and a wireless transmitter for sending a wireless transaction protocol signal.

In a second aspect of the present invention, a method-for providing limited access comprises the steps of placing a transaction authentication card within proximity of a limited access control device; and entering biometric input through a sensor located on the transaction authentication card, wherein the transaction authentication card communicates with a limited access control device through wireless communications. The wireless signal transmits a protocol only and not the biometric data.

The present invention provides an identification card that does not require external equipment for identity verification, physical access control, logical access control, financial transaction authentication, and terminal login authentication. A major advantage of the present invention is that the user does not have to provide his or her biometrics to a database that is not controlled by him or her. The transaction authentication card allows biometric data collection on the transaction authentication card's database that is controlled by the user. Authentication is accomplished on the card for a one to one verification.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates a method of use of the present invention;

FIG. 2 illustrates a functional block diagram of the transaction authentication card of the present invention;

FIG. 3 illustrates a frontal view of an exemplary embodiment of a transaction authentication card according to the present invention;

FIG. 4 illustrates a side view of the transaction authentication card in an embodiment of the present invention;

FIG. 5 illustrates a cutaway view of an embodiment of the present invention;

FIG. 6 illustrates a cutaway view of an embodiment of the present invention in which a solar cell is used;

FIG. 7 illustrates an exemplary embodiment of a circuit block diagram of the present invention;

FIG. 8 illustrates operation of the biometric sensor of the present invention;

FIG. 9 illustrates a close up view of an exemplary embodiment of the biometric sensor of the present invention;

FIG. 10 illustrates fingerprint measurement or identification points used in an embodiment of the present invention;

FIGS. 11A and 11B illustrate an embodiment of the present invention in which the display uses color pass filters;

FIGS. 12A and 12B illustrate an embodiment of the present invention in which the display uses a liquid crystal display;

FIG. 13 illustrates an embodiment of the method of the present invention including enrollment and verification;

FIG. 14 illustrates an embodiment of a method of gaining limited access using a transaction authentication card with biometric input in the present invention;

FIG. 15 illustrates an embodiment of a method of enrollment and initial use of the transaction authentication card of the present invention using a universal serial bus (USB) connection; and

FIG. 16 illustrates another embodiment of a method of enrollment and initial use of the proximity of the present invention using wireless communications;.

### DETAILED DESCRIPTION OF THE INVENTION

Reference will now be made in detail to the presently preferred embodiments of the invention, examples of which are illustrated in the accompanying drawings.

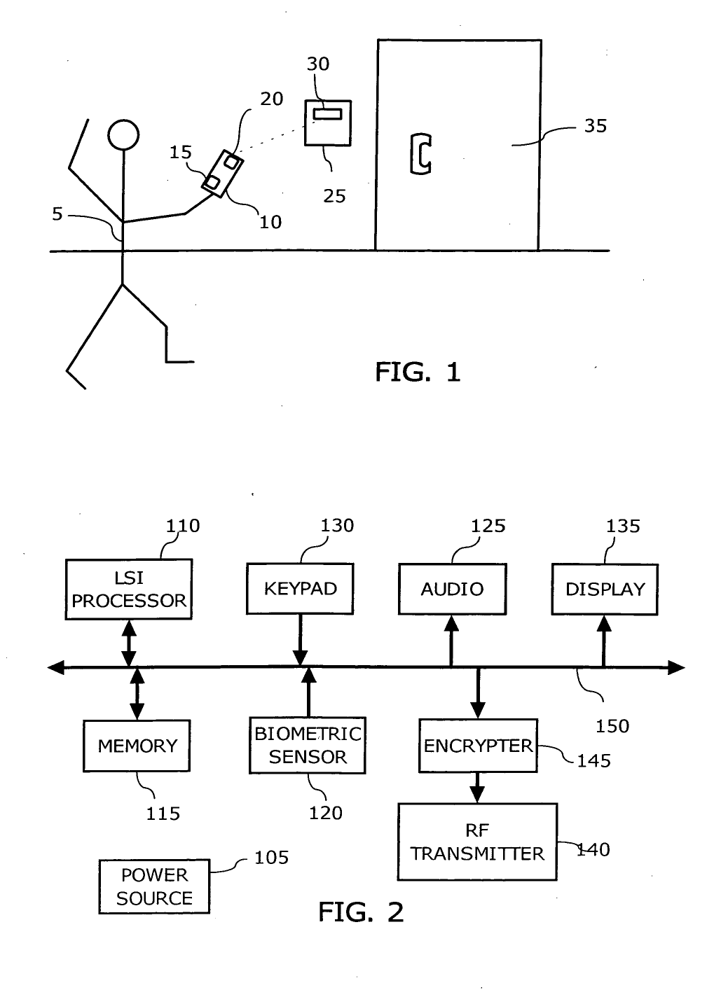

The present invention relates to a transaction authentication card having an antenna that emits radio frequencies compliant with FCC standards and formats for access control market place (e.g., HID Mifare). The transaction authentication card does not contain an operating system and does not contain a desktop application. The transaction authentication card is not a personal digital assistant (PDA), a palmtop computer, or a palm pilot, although the method of the present invention may be used with these devices. The card may be a proximity card or an access card for access control to buildings, financial transactions, security transactions, government control, airline security, passport ID, drivers' license/driver authentication, toll road payment and automated teller machine transactions. The transaction authentication card provides a portable database and does not require an outside source for biometric enrollment. As shown in FIG. 1, a user 5 may place a finger on a sensor 15 and, upon authentication, cause a wireless signal from an on-card transmitter 20 to be received by a sensor 30 on an access control box 25. In one embodiment, enrollment of the user occurs when the first user presses his or her finger onto the biometric sensor. In this embodiment, no other person is thereafter able to enroll or use the card. The present invention provides an identification card that does not require external software/equipment for identity verification, access control, and terminal login authentication. The transaction authentication card preferably includes a fingerprint sensor for authenticating the identity of a person, a processor that has the software on board to drive the verification, and access control.

FIG. 2 shows a functional block diagram of the circuitry of the transaction authentication card of the present invention. A large scale integrated (LSI) processor 110 controls the circuitry and, preferably, encrypts all biometric data as well as any other sensitive data, such as personal identification numbers. If reverse engineering were to be attempted, in the preferred embodiment, all the stored data would appear as characters similar to hieroglyphics. The LSI processor 110 may be implemented through field programmable gate array, programmable logic device, or other suitable technology and includes a biometric processor (i.e., engine) for enrollment and verification. The LSI processor 110 may act as a central processing unit (CPU). Enrollment is defined as the process used to collect, build and store in memory the biometric “signature” or “template” of the enrollee or “owner”. It is against this “signature” or “template” that the cardholders' biometric data collected at the time of attempted authentication/verification will be matched. In this document, authentication and verification should be used interchangeably. Authentication/verification is the process of comparing the cardholders collected biometric data against the stored biometric “signature” or “template” (collected at enrollment) in order to achieve a match, thereby “authenticating” the cardholder as the card owner. As to the device, this authentication is of course necessary prior to the device sending its signal (either through an RF interface, through the “smart card” interface, or through a “wired” (Serial, USB, etc) connection or interface).

Biometrics encompassed by the present invention include retinal scans and iris scans, voiceprints, handprints, footprints, fingerprints, palmprints, and handwriting. Preferably, the biometric processor verifies the cardholder's fingerprint against the stored template and sends a wireless signal to an access control device such as one that conforms to the proximity systems that are on the open market. The biometrics matching algorithm may be customized or may be a commercially available algorithm such as through Verifinger (e.g., the Touch Chip sensor), Fujitsu (e.g., the MBF300 SweepSensor), DigitalPersona, or the like which uses industry standard minutia points (i.e., local ridge characteristics at a ridge split or termination) for validation/authentication. The transaction authentication card processing software may also have the capability of having a settable resolution threshold for biometric matching. For example, fingerprint matching may be accomplished by the matching of a settable number of points, such as six points or sixteen points. Setting of the number of points is preferably done by the manufacturer, but may be specified by the user. The transaction authentication card incorporates memory that stores fingerprint information about the transaction authentication card owner. The memory includes read only memory (ROM), such as electrically erasable programmable read only memory (EEPROM) or flash memory, to store card identification information for communications with external enrollment or access devices. The ROM preferably also stores the biometric data. In the preferred embodiment, volatile memory (e.g., random access memory or RAM) temporarily stores the data to be transmitted through the wireless transmitter. The card serial number may be hardwired on the card by tying certain signals as highs and lows to represent a bit pattern that identifies the card. Alternatively, the memory may include static random access memory (static RAM) such that when the power source is dead or disconnected, all biometric data is erased.

Preferably, smart chip technology is used. Smart Chip Technology (SCT) refers to an embedded chip common in new style “smart card” credit/debit cards where account information is contained on the chip. The device would require authentication prior to releasing data contained on the “smart chip.” The device may use SCT simply as a storage medium for the enrollee's biometric signature or as an actual interface to a commercially available “smart card” reader, thus enabling “smart card” transactions in a merchant-consumer, or other financial transaction environment. (Examples would be credit/debit cards, calling cards, stored value cards, ATM cards, etc.)

The preferred transaction authentication card communications gateways are PCMCIA, serial, universal serial bus (USB), and radio frequency (RF). In an embodiment, the smart chip itself may be used as a communications port. A transaction authentication card having a PCMCIA interface is preferably connected to a desktop computer via a USB serial data interchange. Biometric and other data for enrollment is registered on the transaction authentication card by enrollment software resident on the desktop computer or on another registration device. The enrollment data stored on the card is continuously available to a user with verifiable biometric input.

In FIG. 2, the LSI processor 110 receives input from the biometric sensor 120 and sends a signal, upon authentication of a user, to an encrypter 145 that provides a signal to a wireless transmitter 140. The LSI processor may be implemented through large-scale integration, very large scale integration, and/or ultra large-scale integration technologies. Various encryption techniques may be employed including the Data Encryption Standard. The card may allow encryption keys to be changed regularly—perhaps through software control using a USB interface. The card is preferably always in a sleep mode unless activated to an active mode by a user's biometric on or in readable proximity to the biometric sensor. Alternatively, the card may have an ON/OFF switch. A power source 105, preferably a flat battery powers all the card circuitry. On the card is a memory 115. Optionally, the card may have audio 125, a visual indicator 135, and/or a keypad 130. Each card has an RF ID number as configured by the manufacturer as a default. The RF ID may be active or passive. There are at least two types of transaction authentication cards of the present invention: a PCMCIA interface card and a completely enclosed factory default card for radio frequency transmission. The transaction authentication card serial ID may be encrypted at the point of manufacture. The transaction authentication card may transmit an encrypted radio frequency signal with encrypted data.

The transaction authentication card may have a ridged form factor for the PCMCIA interface. The transaction authentication card may store biometric data for one to one verification. The transaction authentication card may store data in multiple configurations. The transaction authentication card may have the ability to store biometrics with the use of a computer. The transaction authentication card may store user biometrics. The transaction authentication card may allow for more than one biometric for verification

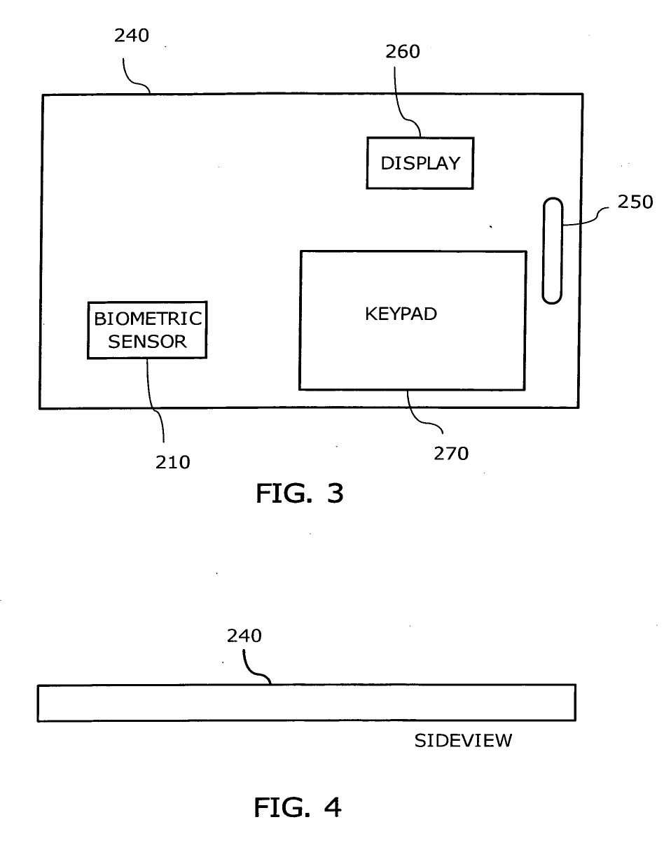

FIG. 3 illustrates a frontal view of an exemplary embodiment of the transaction authentication card. On the front side of the card 240, a biometric sensor 210 is placed. The biometric sensor may have a slidable or removable cover to protect against the accumulation of dust. Alternatively or additionally, the transaction authentication card may be placed in a protective jacket. A display 260 is also provided. The display may be a single tristate LED, a liquid crystal display (LCD), or a more elaborate optical lighting arrangement. An optional keypad 270 is shown. The transaction authentication card may have a keypad membrane alphanumeric for personal identification entry along with biometrics. When the card is equipped with non-volatile memory, an on/off switch may be provided.

FIG. 4 shows a preferred embodiment of the transaction authentication card 240 in which the height of the card remains uniform throughout the length of the card. The transaction authentication card may be manufactured in many different form factors. The card is approximately the size of a Personal Computer Memory Card International Association (PCMCIA) card and may be an inch or so longer. Preferably, the transaction authentication card has a uniform cross section and slim, uniform profile, and measures less than 4×6 inches and has a height of less than ½ inch. In one embodiment, the card measures 3⅜×2⅛× 3/16 inches. The backside 240 may be of a protective material with no visual indicia, may have a photo ID printed on it, or may have a processed reserved area to permit such to be printed. The photo ID or other image may be printed on the front side or the back side of the card. A perforation or hole 250 in the body of the card may allow for attachment via a chain or strap. The body may be built with impact plastics and/or metal and/or may be rigid or pliable. A rigid body is preferred. Reinforcing ribs may be added on the inner surfaces of the front and back of the card body to provide greater strength.

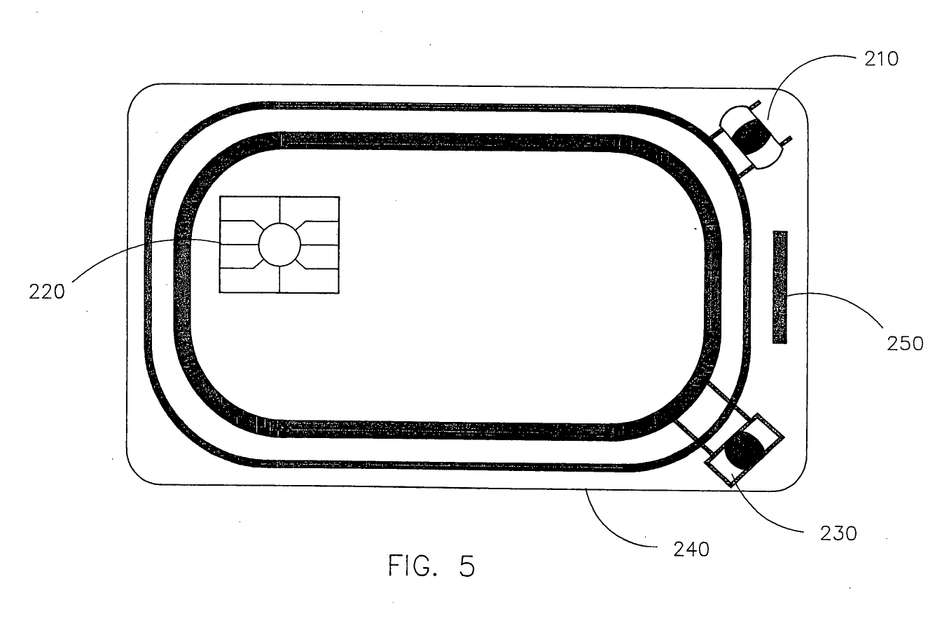

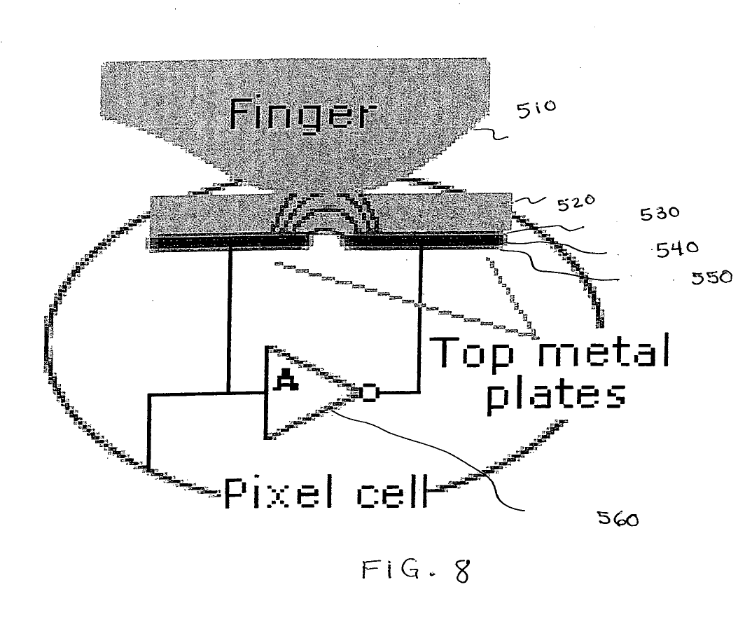

FIGS. 5-7 show cutaway views of various embodiments of the transaction authentication card. In FIG. 7, an RF transmitter 210 is electrically connected to a loop antenna and a biometric sensor 230 is connected to conductive traces or wires that lead to processing circuitry 220. The biometric sensor may have a lid or cover to prevent dust buildup and to protect the sensor when not in use. The biometric sensor 230 is preferably a fingerprint sensor of either the capacitive or scanning type. If used, the capacitive type sensor may be either an active capacitive pixel sensing sensor or a passive capacitive sensor. The active capacitive sensor offers a higher signal-to-noise ratio and greater resolution; the passive capacitive sensor is lower cost than the active capacitive sensor. In one embodiment, the Verifinger Touch Chip sensor is used as the biometric sensor 230. An optical sensor may be used as the biometric sensor.

The processing circuitry 220 interfaces the biometric sensor 230 and RF transmitter 210. When the cardholder activates the authentication, the RF signal is sent to the transaction authentication card. The RF signal may be a direct sequence signal or a frequency-hopping signal. The transaction authentication card has a radio transmitter that transmits in the range from 1 kilohertz to 999 gigahertz and may have a receiver that receives in the range of 1 kilohertz to 999 gigahertz. RF transmission may be in accordance with Bluetooth or IEEE 802.11 standards. Radio frequency transmission is only accomplished when the biometric in the on-board database is authenticated with the biometric input from the user. The effective range of the RF signal may be zero to five feet or zero to four inches or another range. The card may be implemented to emit RF signals of two or more distinct frequencies. The RF signals may be implemented such that the frequency of a first signal is between two (2) and one billion (1000000000) times the frequency of a second signal. Optionally, a switch may be added to the card to switch to one of multiple transmission frequencies. Each transmission frequency may correspond to a unique encrypter.

The wireless output data format may be application specific or may adhere to a recognized access control system standard. The transaction authentication card preferably uses a standard PCMCIA interface to allow computer terminal authentication and has a PCMCIA form factor that permits charging of the battery and terminal authentication. An additional interface will be wireless to a computer terminal that uses the protocol compliant with or identical to HID/MIFARE. The transaction authentication card preferably has a proximity antenna built into the card and will support various communications standards. The transaction authentication card interfaces through a serial (e.g., USB) port on the computer terminal. Biometric data is enrolled at the card level without the need of a CPU.

In the preferred embodiment, the transaction authentication card supports embedded contact smart chip module access control. In the preferred embodiment, multiple wireless protocols are used such as the HID and MIFARE protocols. HID Corporation, based in Irvine, Calif., provides the combining of proximity and smart card contactless technologies using Wiegand format access control data. The combined HID MIFARE protocols operate at a frequency of 13.56 (or 15.76) MHz (i.e., MIFARE) and 125 (or 129) KHz Proximity (i.e., HID). In alternative embodiments, the transaction authentication card may use solely HID or MIFARE protocols. The encrypted RF signal using MIFARE is either 26 bits or 32 bits, as selected by the manufacturer. These embodiments preferably use the Philips MIFARE S50 module having an EEPROM memory. The MIFARE read range is 2.5 to 10 cm. An HID MIFARE reader may be used with the transaction authentication card to provide secure access to a building or machine through contactless operation that does not cause wear and tear on the reader.

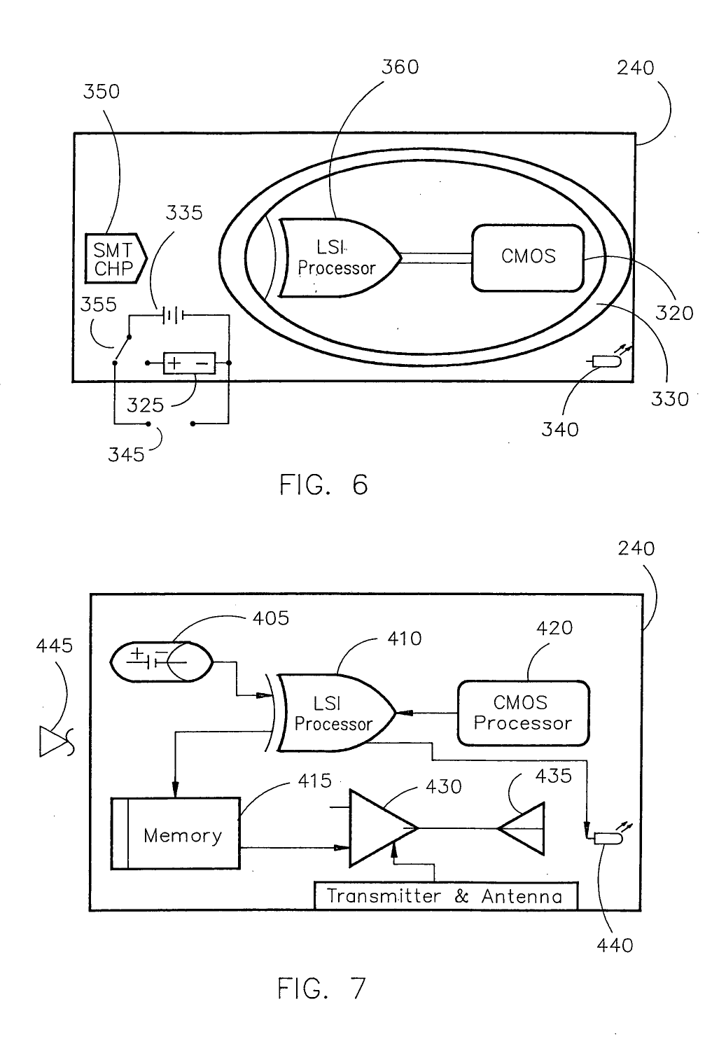

FIG. 6 shows an embodiment having a solar cell 325 to supply at least some of the transaction authentication card power requirements. The transaction authentication card is preferably powered by an internal battery, but may, optionally, be externally powered, such as by an adapter. The internal battery may be one or more flat batteries and may be a nominal 1.5 volt battery. A solar cell or capacitor may be used as the power source. Redundant power supplies may be used. A flat battery 335, assisted by a capacitive power cell and/or a micro solar cell 325, preferably supplies the power requirements. The flat battery may be long life and/or rechargeable through terminals 345 connectable to an external power source or recharger. Lithium ion batteries may be used. A switch 355 may be provided to switch to a recharge mode, to switch from a solar power mode, or to switch between a solar power mode and a recharge mode. In one embodiment, when the transaction authentication card is in a terminal port such as on a personal computer or other external device, the transaction authentication card battery or batteries are recharged. Also included in the embodiment of FIG. 6 are a smart chip 350, a large-scale integration processor 360, a fingerprint sensor 320, an antenna 330, and an indicator LED 340. The data is preferably encrypted before being transmitted wirelessly. In the embodiment of FIG. 6, the processor is the brain and the smart chip is used for MIFARE, as an interface, and provides dynamic memory.

FIG. 7 shows an exemplary functional block diagram of the circuitry and housing designs in an embodiment of the present invention. The transaction authentication card includes an electrolytic battery 405, a processor 410, a fingerprint sensor 420, a memory 415, a transmitter 430, PCMCIA interface 445, and an antenna 435. Light emitting diodes (LEDs) 440 may also be used. A single multicolor LED may be used to indicate two or more states of the processing by the transaction authentication card. Although a bicolor or bistate LED may be used, a tristate LED or a set of LEDs is preferably located on the card to indicate state of enrollment, good read/biometric data, and low battery. The LED may have a blink mode and a steady state (i.e., non-blinking) mode to enhance viewability. The light emitting bodies of the LED or LEDs may protrude completely from the body of the card, may protrude partially from the body of the card, may be nested with a depression on the card body, or may be fully contained with the card. In the nested embodiment, the body of the card may have a conical depression with an apex directed to the interior of the card. The LED, when nested on the card body or contained within the card, may be covered with a protective adhesive sheet.

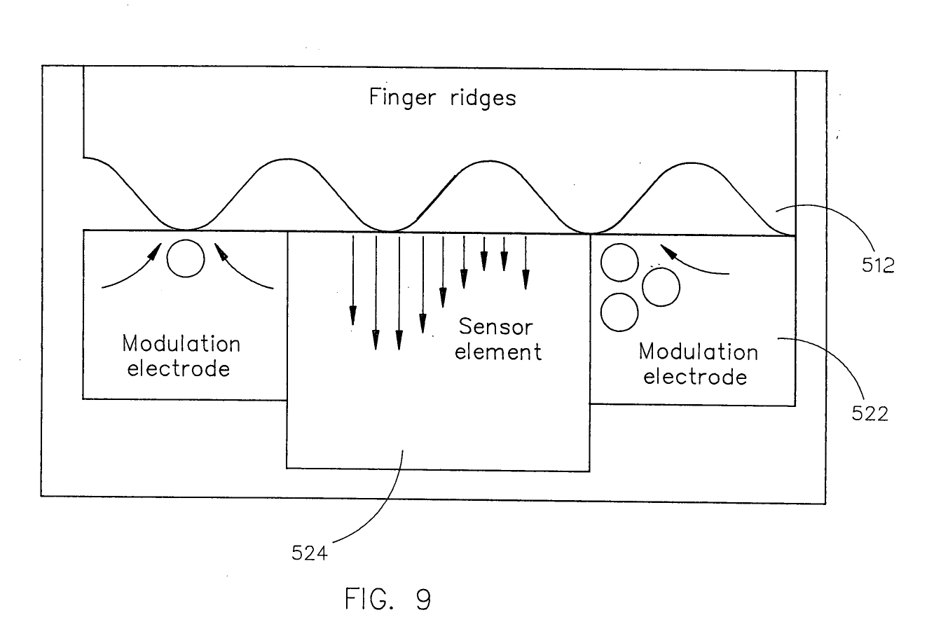

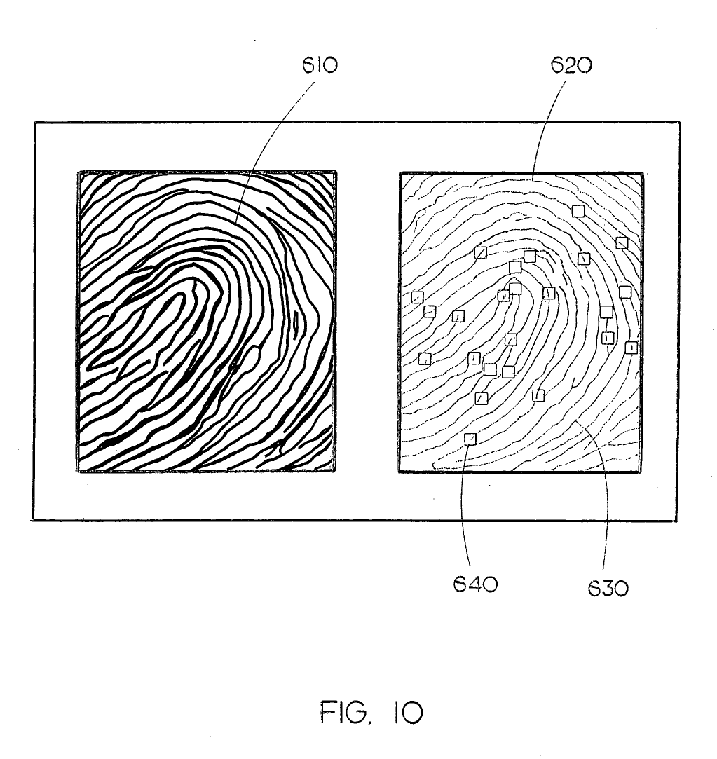

FIGS. 8-10 illustrate an exemplary embodiment of the operation of a biometric sensor. A finger 510 contacts a dielectric material 520 and passes a charge to two top plates 530 of two capacitors (conductive layer 530, dielectric layer 540, conductive layer 550). The change in current flow in the circuitry 560 is detected and amplified. FIG. 9 shows an embodiment in which current is passed from modulation electrodes 522 through finger ridges 512 to a sensor element 524. A processing algorithm may create a data table for the fingerprint. The data table may correspond to the fingerprint ridge pattern 620 (as shown in FIG. 10), finger blood vessel pattern, or both. In an embodiment, multiple data points 640 may correspond to particular locations on a fingerprint. The whorls and loops on a fingerprint may be mapped for further analysis. An additional sensor may be used to detect that the finger is of an appropriate temperature. In an example of use, if a user waves the transaction authentication card over an RF interface, the transaction authentication card light may turn yellow. Upon placement by the user of his finger upon the CMOS sensor, the transaction authentication card light may turn green if the user has his biometric stored on it. A red light may indicate low battery when it is steadily on and may flash when the battery is charged.

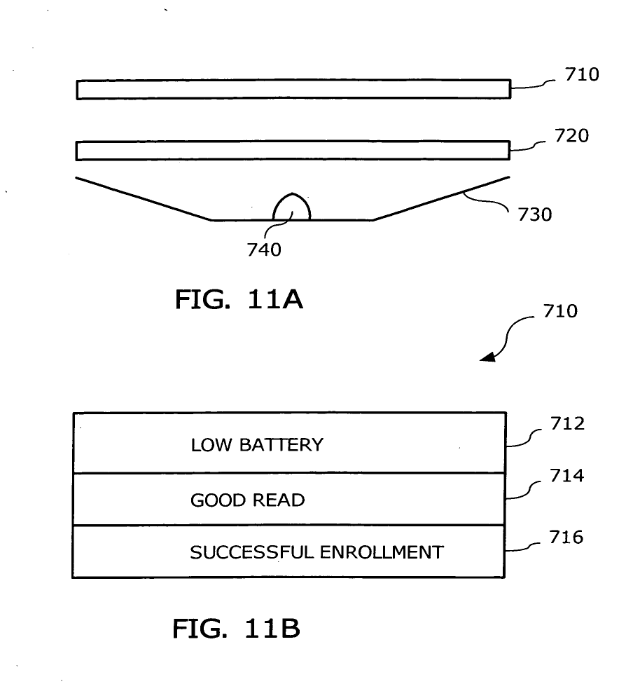

FIGS. 11A and 11B illustrate an embodiment of a display in which a tricolor LED is used with three side-by-side color pass filters. For an LED 740 that transmits yellow, green, and red, color filters 720 that pass only yellow spectrum light, green spectrum light, or red spectrum light preferably are used. A reflector 730 directs the light to achieve greater light efficiency. Top panel 710 may be implemented as three side-by-side panels 712, 714, 716. For example, one panel 712 may contain text inscribed or printed on the panel surface that reads “LOW BATTERY.” This panel may be located over a yellow spectrum light only pass filter 720. When the LED transmits yellow light indicating a low battery, only panel 712 is lit. In an embodiment, only when red, green, or yellow light is emitted is one and only one panel lit. In another embodiment, the LED may alternate between colors so as to permit two or more panels to be lit simultaneously. The LED may be formed as part of a tape.

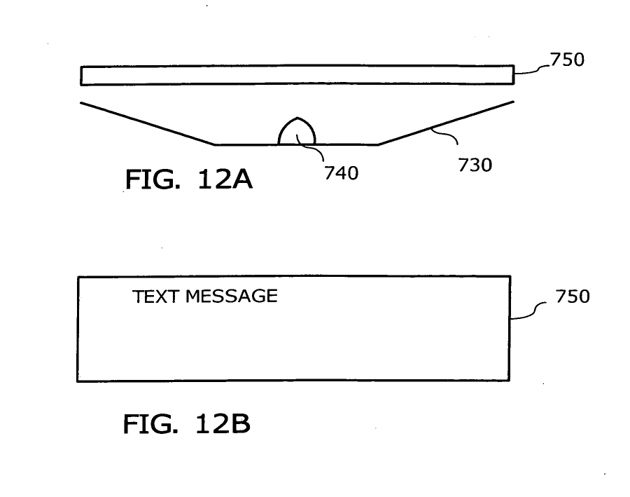

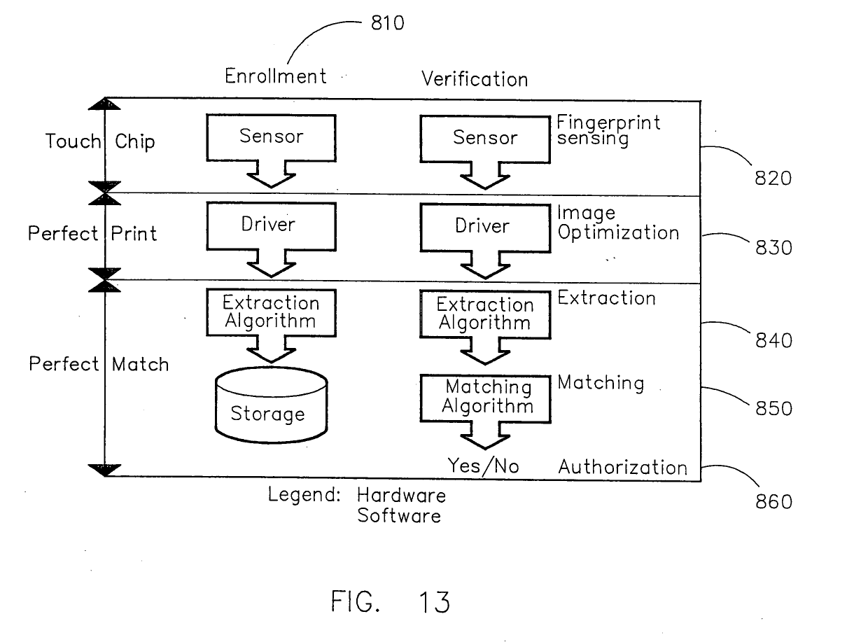

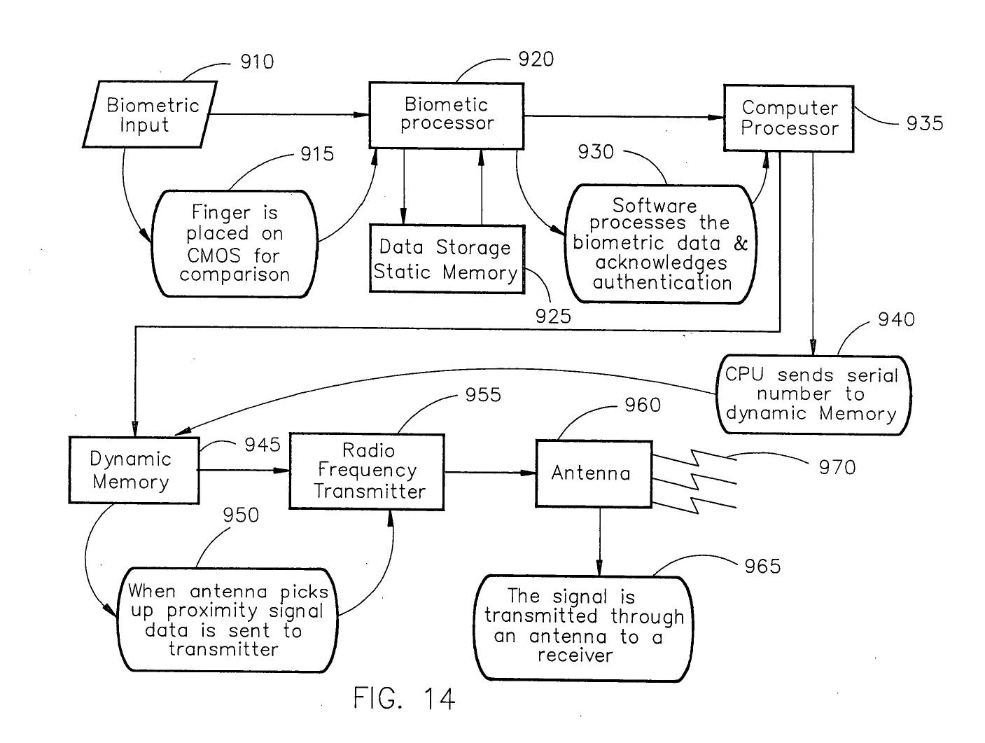

FIGS. 12A and 12B illustrate and embodiment of a display in which an LCD is used. The LCD 750 is backlit by a monochromatic or multicolor light source, such as an LED 740. To achieve greater efficiency in light usage, a reflector 730 is preferably used. The LCD 750 may have color filters when the light source is a white light source. In an embodiment, incident light may be used alone or in conjunction with the light source. Use of an LCD permits a great range of messages to be displayed on the LCD 750. The LCD may be a roll up flexible panel. A passive matrix LCD offers lower cost and is preferred; however, an active matrix LCD may be used for applications requiring better resolution. The liquid crystal material of the LCD may be untwisted nematic, twisted nematic, cholesteric, discoidal, or the like. Polarizers, microlenses, and other optical elements may be used. The display may depict images downloaded by the user, such as a photo, and must be capable of displaying text of at least one alphanumeric character. Other displays may be used such as electrochromic or electroluminescent displays.

FIG. 13 illustrates an embodiment of the method of the present invention including enrollment and verification. In an exemplary use of the present invention, a tab is preferably pulled to engage the internal battery. By placement of a finger (e.g., thumb and/or middle) on the fingerprint window, that user's bioprint is stored in a processor (e.g., LSI). Enrollment is on the card only and does not require a PC or other device for biometric enabling. The default RF ID needs to be entered for the access control system for ID acknowledgement. Remote enrollment or local enrollment may be performed. Remote enrollment is a process similar to credit card activation. Local enrollment may be achieved by placing the transaction authentication card in an interface dock allowing a higher level of enrollment control. Software loaded on a desktop may prompt for a personal identification number before allowing the transaction authentication card to enroll the biometric. The user places a finger on the fingerprint window for authentication and verification that the user is authorized to use the transaction authentication card. If the fingerprint is not acceptably recorded, the card may prompt for a redo such as by providing a display or lighting an LED a particular color. Access may be accomplished by placing the transaction authentication card within several inches of an HID plate. Likewise, when the device is used with a desktop input device for terminal or computer access and/or internet credit card transactions, the transaction authentication card is placed in an interface box to complete a smart card transaction or send an encrypted token for terminal access.

FIG. 14 shows a flowchart for an exemplary process of the present invention. A biometric input 910, such as a finger placed on a CMOS sensor 915, is processed by a biometric processor 920. A template of acceptable fingerprint patterns is retrieved from memory 925, such as a read only memory (or static random access memory for applications which erase biometric data when power is lost on the card). The processor software processes the biometric data and acknowledges authentication 930. If the fingerprint is not authenticated, an alert may be set by the transaction authentication card or the transaction authentication card reader. For an authenticated fingerprint, the processor (e.g., central processing unit) sends the serial number to dynamic memory 940, 945. Dynamic memory is either a dynamic random access memory or a static random access memory. When the transaction authentication card antenna receives a proximity sensor from the transaction authentication card reader 950, data is sent to the transaction authentication card transmitter 955. The encoded data is transmitted through the antenna 960, 965 to a receiver as a wireless signal 970, such as radio frequency or infrared. The antenna is preferably a loop antenna. The loop antenna may have a cross sectional area only slightly smaller than the major planar extension of the transaction authentication card body.

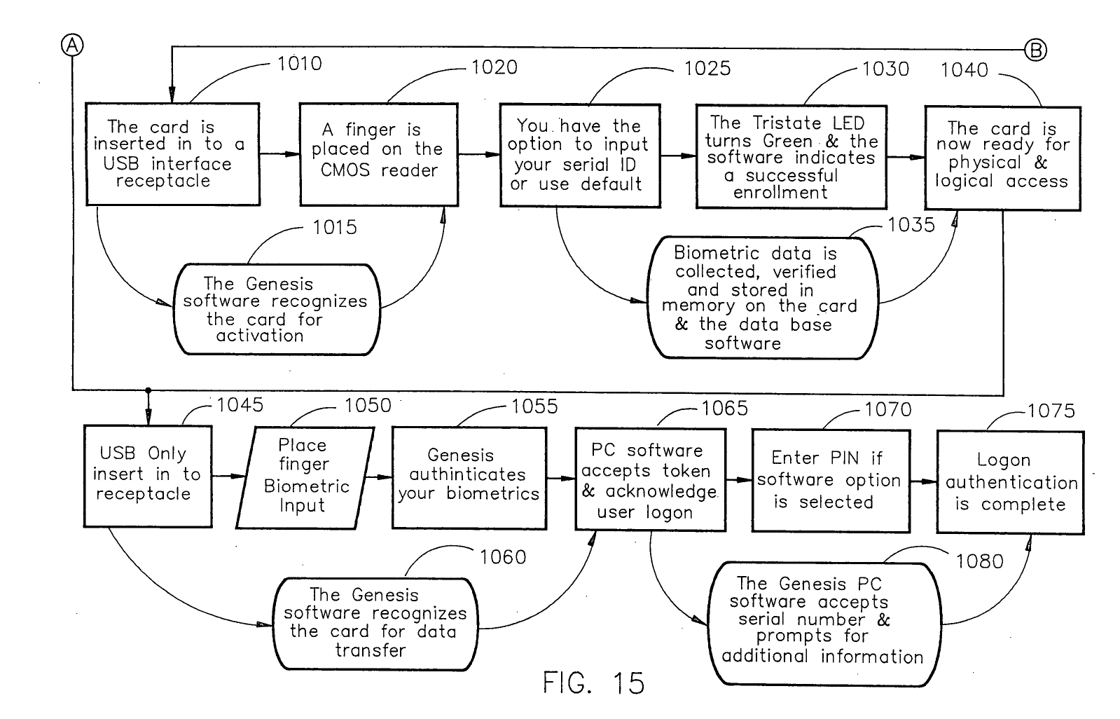

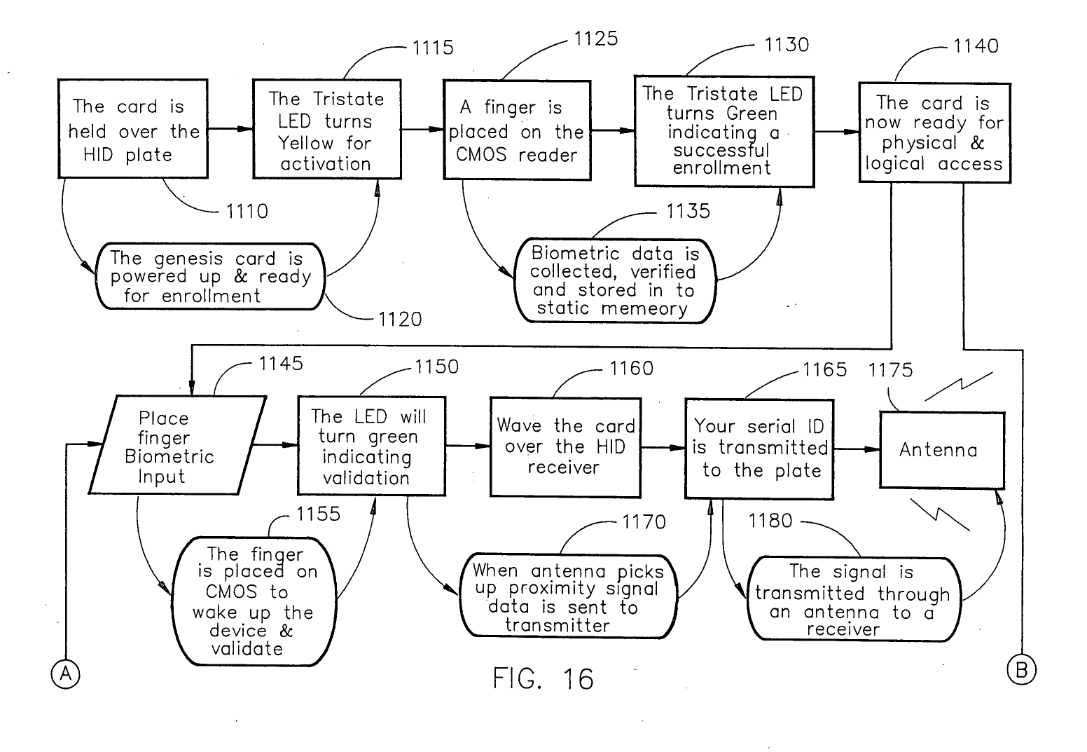

FIG. 15 shows a flowchart for an exemplary process for initial use and enrollment in the present invention. The transaction authentication card is inserted into a USB interface receptacle 1010. The biometric input is received 1020. The transaction authentication card processor software and/or hardware recognizes that the card is to be activated 1015. This recognition may be achieved by the setting of a flag bit in a register in the transaction authentication card. An option may be presented to the user in which the user may input his or her own serial identification number or may simply accept a default identification number (or, code) 1025. A tristate LED may turn green to indicate that the software has acknowledged successful enrollment by the user 1030. The biometric data is collected, verified, and stored in memory on the transaction authentication card and in the database software 1035. Then, the transaction authentication card is ready for physical and logical access 1040.

FIG. 15 also shows a flowchart for an exemplary process of initial use using a USB receptacle. The transaction authentication card may have a USB port 1045 from which a USB cable may connect the transaction authentication card to an external device, such as a personal computer. The user's biometric input is received 1050 and authenticated 1055. The transaction authentication card software recognizes the transaction authentication card for data transfer 1060. A token from the transaction authentication card is accepted by the personal computer software and the personal computer acknowledges a user logon 1065. A personal identification number may be required by the personal computer software application 1070. The personal computer software accepts the transaction authentication card serial number and prompts for additional information 1080. Logon authentication is completed 1075.

FIG. 16 shows a flowchart for another exemplary process for initial use and enrollment in the present invention. In this embodiment, enrollment and initial use is achieved wirelessly. The transaction authentication card 1110 is placed over a human interface device (HID) plate interfaced to a CPU. The transaction authentication card is powered up for enrollment 1120. An optional tristate LED (light emitting diode) turns yellow for activation 1115. Biometric input is received 1125, such as by placing a finger on a CMOS sensor. The biometric data is collected, verified, and stored into static memory 1135. The tristate LED turns green indicating a successful enrollment 1130. The transaction authentication card is ready for logical and physical access 1140.

In the initial use phase of FIG. 16, the biometric input is received 1145. In the present example, when a finger is placed on the CMOS sensor, the transaction authentication card circuitry wakes up from sleep mode and runs a validation check on the fingerprint 1155. The tristate LED turns green if validation is successful 1150. The transaction authentication card is waved over a human interface device receiver 1160. When the transaction authentication card antenna receives a proximity signal, data is sent to the transmitter 1170. The serial identification data is transmitted 1165 through an antenna 1180, 1175. The antenna is preferably a loop antenna, but may be a quarter wave antenna, a dipole antenna, a half wave antenna, or the like. The antenna may be a fold out antenna or may be attachable to the transaction authentication card housing. The transaction authentication card may have a telescopic antenna for long-range RF transmissions.

Various embodiments may be implemented for the transaction authentication card of the present invention. The biometric input need not be limited to fingerprint matching, but may include other forms of biometric identification. The transaction authentication card may allow multiple finger print registration. Patterns for each finger of the user may be entered into the transaction authentication card memory. Other parts of the user's anatomy, such as the retinal patterns of the eyes, may be used. The sensor pad may be adapted to require the placement of two or more digits and may function in an either/or mode. A temperature sensor may also be employed to verify that the finger is living. This may be a redundant feature in some embodiments since the sensor pad and processor may already be implemented to recognize not only a finger print pattern but also the blood flow through a given finger. In fact, the blood flow pattern through a finger may be used as an alternative to a fingerprint. Flexible circuit technology may be used. The transaction authentication card may store credit card numbers, social security numbers, employee identification numbers, and the like. Although radio frequency transmission is preferred, other wireless transmission formats may be implemented, such as infrared. Misalignment or other problems in entering the biometric input may be signaled by an audible alarm or visual indicator on the transaction authentication card and/or transaction authentication card reader. A speaker for sound and/or alarms may be incorporated in the card. A protective adhesive sheet may cover one or both sides of the card. If the biometric side of the card is covered with a protective adhesive sheet, the protective adhesive sheet over the biometric sensor may be cut out to promote effectiveness of the sensor operation. The protective adhesive sheet may allow the adhering of print images or text.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

1. A transaction authentication card, comprising:
a biometric sensor for sensing a biometric feature of a user;
a memory;
a processor for retrieving stored biometric data representing said biometric feature from the memory, the processor having a fingerprint matching algorithm for comparing a biometric feature of a user with the stored biometric data; and
a wireless transmitter capable of generating wireless signals of two different frequencies, wherein a wireless signal is transmitted on a one-to-one validation of the biometric feature, wherein the transaction authentication card is a stand alone device and performs self authentication, self verification, and self enrollment.

2. The transaction authentication card of claim 1, further comprising a loop antenna, wherein the wireless transmitter is a radio frequency transmitter.

3. The transaction authentication card of claim 2, wherein a frequency of the radio frequency transmitter is between 1 KHz and 999 GHz.

4. The transaction authentication card of claim 3, wherein the wireless transmitter is an infrared transmitter.

5. The transaction authentication card of claim 1, wherein the wireless signal is formatted as a human interface device (HID) signal.

6. The transaction authentication card of claim 5, wherein the human interface device signal is compatible with Mifare.

7. The transaction authentication card of claim 1, further comprising a power supply.

8. The transaction authentication card of claim 7, wherein the power supply is rechargeable.

9. The transaction authentication card of claim 7, wherein the power supply is a battery or capacitor.

10. The transaction authentication card of claim 1, wherein the wireless signal is encoded.

11. The transaction authentication card of claim 1, further comprising a multicolor light emitting diode.

12. The transaction authentication card of claim 1, wherein the multicolor light emitting diode indicates a first color for a good read and a second color for a low battery.

13. The transaction authentication card of claim 12, wherein the multicolor light emitting diode indicates a third color for a state of enrollment.

14. The transaction authentication card of claim 1, wherein the transaction authentication card is used with a financial transaction terminal or an automated teller machine terminal.

15. (canceled)

16. The transaction authentication card of claim 1, further comprising a telescopic antenna coupled to the transmitter.

17. The transaction authentication card of claim 1, wherein the memory stores biometric data for multiple users or multiple biometric data for a single user.

18. The transaction authentication card of claim 1, wherein data sent by the wireless transmitter is encrypted.

19. The transaction authentication card of claim 1, wherein the transaction authentication card provides more than one biometric for verification.

20. The transaction authentication card of claim 1, wherein the biometric sensor is on a front side of the card and wherein an image is formed on a back side of the card.

21. The transaction authentication card of claim 1, wherein the card is used for access control, financial transactions, security transactions, government control, airline security, passport ID, and driver's license or authentication.

22. The transaction authentication card of claim 1, further comprising a display for showing an image downloaded by a user.

23. The transaction authentication card of claim 22, wherein the image is a photo id.

24. The transaction authentication card of claim 22, wherein the image is text.

25. The transaction authentication card of claim 1, further comprising an alphanumeric keypad membrane for personal identification entry.

26. The transaction authentication card of claim 1, wherein the wireless transmitter is an RF transmitter that operates between 1 KHz and 999 GHz.

27. The transaction authentication card of claim 26, further comprising an RF receiver that is capable of receiving a signal between 1 KHz and 999 GHz.

28. The transaction authentication card of claim 1, further comprising one or more batteries that supply power to the biometric sensor, the memory, the processor, and the wireless transmitter on the card.

29. The transaction authentication card of claim 1, wherein the card has a portable database and does not require an external source for biometric enrollment or verification.

30. The transaction authentication card of claim 1, wherein the processor uses industry standard minutia points for verification.

31-41. (canceled)

42. A transaction authentication card, comprising:
a body in the general form of a rectangular solid having a substantially hollow interior, the body measuring between 1 to 5 inches on a first side, 1 to 4 inches on a second side substantially perpendicular to the first side, and ⅛ to ½ inch on a third side substantially perpendicular to the first and second sides, the body being formed of impact plastics.
a fingerprint sensor for sensing minutia points of a fingerprint of a user, the fingerprint sensor being mounted to an inside of the body such that a sensing portion of the fingerprint sensor is exposed through an opening in the body;
a first memory and a second memory, the first memory storing a database of enrolled fingerprints and the second memory being a read only memory for storing an identification code for the transaction authentication card, the identification code serving to identify the card to an access control device;
a processor for retrieving stored biometric data representing a biometric feature of said user from the first memory, the processor having a fingerprint-matching algorithm for comparing said biometric feature of a user with the stored biometric data, the processor reading a fingerprint pattern from the fingerprint sensor, the processor sending a signal to be transmitted;
an encrypter for encrypted the signal to be transmitted;
a radio frequency (RF) transmitter for transmitting the encrypted signal on a one-to-one validation of the fingerprint of the user, the RF transmitter capable of transmitting a first RF signal of a first frequency and a second RF signal of a second frequency, wherein the first frequency is between 100 KHz and 200 KHz and the second frequency is between 10 MHz and 20 MHz;
an antenna coupled to the RF transmitter for transmitting the RF signal;
a three color light emitting diode mounted on the body such that a first color indicates a first condition, a second color indicates a second condition, and a third color indicates a third condition; and
an internal power supply for powering all circuitry with the card, wherein said processor is configured for enrollment of said biometric feature of said user and storage of said biometric data representing said biometric feature of said user acquired during enrollment within said first memory.

43. The transaction authentication card of claim 42, wherein the body measures 3⅜×2⅛× 3/16 inches.

44. The transaction authentication card of claim 42, wherein the first frequency is 13.56 MHz and the second frequency is 125 KHz.

45. The transaction authentication card of claim 42, wherein the first frequency is 15.76 MHz and the second frequency is 129 KHz.

46. The transaction authentication card of claim 44, wherein the antenna is a loop antenna.

47. The transaction authentication card of claim 44, wherein the antenna is a telescopic antenna.

48. The transaction authentication card of claim 1, further comprising a biometric sensor cover access port.

49. The transaction authentication card of claim 1, further comprising a system for erasing data.

50. The method of claim 31, further comprising the step of generating a serial number based on the biometric input.

51. The method of claim 31, further comprising the step of engaging a biometric sensor cover access port, enabling the transaction authentication card to be cleared and used again.

52. The method of claim 31, further comprising the step of erasing the transaction authentication card.

53. The transaction authentication card of claim 42, further comprising a biometric sensor cover access port to enable the transaction authentication card to be cleared and used again.

54. The transaction authentication card of claim 42, further comprising a system for erasing data if the body is opened.

55. A transaction authentication card, comprising:
a biometric sensor for sensing a biometric feature of a user;
a memory;
a processor for retrieving stored biometric data representing a biometric feature of said user from the memory, the processor having a fingerprint matching algorithm for comparing a biometric feature of a user with the stored biometric data and a serial number generation algorithm for generating a serial number based on the fingerprint matching algorithm; and
a wireless transmitter capable of generating wireless signals, wherein a wireless signal is transmitted on a one-to-one validation of the biometric feature, wherein said processor is configured for enrollment of said biometric feature of said user and storage of said biometric data representing said biometric feature of said user acquired during enrollment within said first memory.
